(19) United States
(12) Patent Application Publication
(10) Pub. No.: US 2009/0194314 A1
(43) Pub. Date: Aug. 6, 2009

(54) Bimetallic Wire with Highly Conductive Core in Oilfield Applications

(76) Inventors: Joseph Varkey, Sugar Land, TX (US); Vadim Protasov, Houston, TX (US); Jose Ramon Lozano-Gendreau, Stafford, TX (US)

Correspondence Address: SCHLUMBERGER IPC;ATTN: David Cate, 555 INDUSTRIAL BOULEVARD, MD-21, SUGAR LAND, TX, 77478, US

(21) Appl. No.: 12/346,155

(22) Filed: Dec. 30, 2008

Related U.S. Application Data
(60) Provisional application No. 61/025,007, filed on Jan. 31, 2008.

(51) Int. Cl. H01B 9/02; H01R 43/00

(52) U.S. Cl. 174/103; 29/825

(57) ABSTRACT

A cable and a method of making the cable includes an electrically conductive cable core for transmitting electrical power and at least one layer of a plurality of armor wires surrounding the cable core. At least one of the armor wires is a bimetallic armor wire having a coaxial inner portion and a surrounding outer portion. The inner and outer portions are formed of different metallic materials and the bimetallic armor wire provides a return path for the electrical power transmitted through the cable core.

### CROSS-REFERENCE TO RELATED APPLICATION

This application is entitled to the benefit of, and claims priority to, provisional patent application Ser. No. 61/025,007 filed Jan. 31, 2008, the entire disclosure of which is incorporated herein by reference.

### BACKGROUND

The statements in this section merely provide background information related to the present disclosure and may not constitute prior art.

Embodiments of cables relate generally to oilfield cables and, in particular, to wireline and slickline cables, and methods of making and using such cables.

Mono-cables with alloy armor wires typically comprise a single insulated copper conductor at the core for both electrical transmission and telemetry functions. With mono-cables, electric power is transmitted down the central, insulated power conductor and the electric power returns along the armor. However, with long length alloy cables, electrical power return on them is not possible as a galvanized steel armor package is utilized and the highly resistive nature of alloy wires, such as MP35N and HC-265), effectively precludes the production of long length mono-cables with alloy armors. In order to overcome this issue, coaxial cables were introduced. With coaxial cables, the electrical power is transmitted down a central, insulated conductor, and returns along a serve layer of stranded copper wires covered by a thin layer of polymeric insulation located near the outer edge of the cable core. Both mono-cables and coaxial cables have disadvantages.

Mono-cables are disadvantageous because the amount of electrical power that can be transmitted in long length cables is limited depending on the type of armor wire used. While standard galvanized improved plow steel (GIPS) armor wires have a fairly low resistance, armor wires composed of MP35N/HC-265 or high-carbon alloys (such as those used in wells with a presence of H₂S) can have up to 20 times the resistance to electrical current. Thus the length of the cable with alloy armor wires is limited.

Coaxial cables are disadvantageous because of the potential of breaking the relatively small size of the coaxial cable insulation, which could lead to electrical discharge to armor, and because the small size of the copper wire is difficult to strand block, which increases the possibility of gas migration between the serve layer and the insulation. There is shown in FIGS. 1A and 1B common potential failures associated with prior art coaxial cables. As shown in FIG. 1A, a typical coaxial cable 10 has a core formed from a central, multi-stand conductor 11 encircled by a layer of stranded copper shielding wires 12, and the core is encircled by metallic armor wire strength members 13 at the outside of the cable. The conductor 11 and the wires 12 are embedded in a polymeric insulation 14. The wires 12 are separated from the strength members 13 by a thin layer 15 of the polymeric insulation 14 located at the outer edge of the cable core. As shown in FIG. 1B, damage 16 to the insulation layer 15 allows the shielding wires 12 to contact the armor wires 13, creating monocable-like electrical current transmission conditions.

Coaxial cables are also disadvantageous because in H₂S environments, the copper typically has to be plated with nickel, which reduces the effectiveness of the power return on the serve layer because the total area of the copper on the serve layer is reduced and because serve layer manufacturing is extremely challenging and time consuming and often results in a higher final cost. Coaxial cables are also disadvantageous because the strand layer defines a large area, which reduces the power carrying capacity of the cable.

To improve power return efficiency in H₂S resistant hepta cables with alloy armors, alloy wires are replaced by polymer-insulated, nickel-plated copper wires used as drain wires and placed within the inner armor wire layer, as shown in FIG. 2. A cable 20 has the central, multi-stand conductor 11 encircled by the layer of stranded copper shielding wires 12. The conductor 11 and the wires 12 are embedded in the polymeric insulation 14 with the thin layer 15 of the polymeric insulation 14 located at the outer edge of the cable core. The core is surrounded by an inner layer of alloy armor wires 21 which is surrounded by an outer layer 22 of alloy armor wires wires. Several of the inner alloy wires 21 are replaced by polymer-insulated, nickel-plated copper drain wires 23. This cable 20, however, is disadvantageous because the mechanical load carrying capacity of the cable is effectively reduced and because of potential issues with z-kinking of the nickel plated copper wires due to dynamic loading which exists in an oil well environment.

Another cable 30 includes three insulated stranded copper conductors cabled in a triad configuration over a conductor insulated with a soft polymer, as shown in FIGS. 3A through 3D. The cable core 30 is assembled as follows. In a step “A”, a stranded copper conductor 31 insulated with a soft polymer 32 is placed at the center of the cable core (FIG. 3A). Alternatively, the conductor is formed from any suitable electrically conductive material. In a step “B”, three insulated conductors 33, 34, 35 are cabled helically over the central conductor 31 in a triad configuration (FIG. 3B). Three un-insulated copper conductors 36, 37, 38 are then cabled into the spaces between the insulated conductors 33, 34, 35 for potential for providing power return, as shown in FIG. 3C. A relatively thick layer of polymeric insulation 39 is extruded over the top of the cabled conductors to complete the small-diameter cable core 30, as shown in FIG. 3D. This cable, however, disadvantageously defines a large area due to insulation required for each conductor, reducing the copper cross section and compromising electrical power delivery.

Copper plated steel wires have been used in various industries with great success for some time. These wires provide excellent power transmission capabilities and strength. However these wires are not suitable for wireline applications due to the severe downhole environment, where alloy cables are used, because copper gets rapidly consumed by H₂S gas and other corrosive gases and fluids which exist in the downhole environment.

As shown in FIG. 4, a conductive slickline core consist of single conductor 41 extruded with polymer material 42 then served with copper wire 43 for electrical power return and extruded with an outer polymer material 44. The slickline core is covered with metal or alloy tubing/cladding 45 which acts as a strength member and/or corrosion protective armor layer. This cable 40 is disadvantageous because the serve layer manufacturing is extremely challenging and time consuming, the serve layer defines a large area, the metallic tube/clad typically has a short lifespan due to limited fatigue life, and enclosing the core with the metallic tube/clad is not cost-effective.

It is desirable, therefore, to provide a cable that overcomes the problems encountered with current mono-cable and coaxial cable designs.

### SUMMARY

An embodiment of a cable includes an electrically conductive cable core for transmitting electrical power and at least one layer of a plurality of armor wires surrounding the cable core. At least one of the armor wires is a bimetallic armor wire having a coaxial inner portion and a surrounding outer portion, the inner and outer portions being formed of different metallic materials. The at least one bimetallic armor wire is adapted to provide a return path for the electrical power transmitted through the cable core. The cable core includes a conductor extruded with at least one surrounding insulating polymeric material. The cable core can include a bimetallic cable core wire having a coaxial inner portion and outer portion, the inner and outer portions of the bimetallic cable core wire being formed of different metallic materials. A matrix formed from a polymeric material can encase the cable core and the at least one layer of armor wires.

Alternatively, the cable core includes a conductor extruded with at least one surrounding insulating polymeric material. Alternatively, the cable core includes a bimetallic cable core wire having a coaxial inner portion and outer portion, the inner and outer portions of the bimetallic cable core wire being formed of different metallic materials. Alternatively, the cable further comprises a matrix formed from a polymeric material and encasing the cable core and the at least one layer of armor wires. Alternatively, the inner portion of the bimetallic armor wire includes at least one of copper material, aluminum material, and beryllium copper material. Alternatively, the outer portion of the bimetallic armor wire is formed of a metal alloy material which includes at least one of MP35N material, HC-265 material, Inconel material, Monel material, and Rene material.

Alternatively, the plurality of armor wires includes corrosion resistant alloy armor wires. Alternatively, the at least one layer of armor wires is an inner layer and including an outer layer of a plurality of armor wires surrounding the inner layer, and wherein the at least one bimetallic armor wire is disposed in the inner layer. Alternatively, the at least one layer of armor wires is an outer layer and including an inner layer of a plurality of armor wires surrounded by the outer layer, and wherein the at least one bimetallic armor wire is disposed in the outer layer. Alternatively, the plurality of armor wires comprises an inner layer and an outer layer and wherein the at least one bimetallic armor wire is disposed in the inner layer and including at least another bimetallic armor wire disposed in the outer layer.

An embodiment of a cable includes an electrically conductive cable core formed from a first metallic material, a metallic shell encasing the cable core and being formed from a second metallic material different than the first metallic material, and a polymer jacket encasing the cable core and the shell. The cable can include a bonding material disposed between and attaching an outer surface of the shell and an inner surface of the polymer jacket. The bonding material can be a thin layer of copper material. The cable can include at least one layer of a plurality of armor wires surrounding the polymer jacket.

Alternatively, the first metallic material includes at least one of copper material, aluminum material, and beryllium copper material. Alternatively, the second metallic material includes at least one of MP35N material, HC-265 material, Inconel material, Monel material, and Rene material.

A method of forming a cable includes: providing an electrically conductive cable core for transmitting electrical power; providing at least one bimetallic armor wire having a coaxial inner portion and a surrounding outer portion, the inner and outer portions being formed of different metallic materials; and surrounding the cable core with at least one layer of a plurality of armor wires including the at least one bimetallic armor wire, wherein the at least one bimetallic armor wire provides a return path for the electrical power transmitted through the cable core. The method can include extruding at least one insulating polymeric material surrounding a conductor to form the cable core and encasing the at least one layer of armor wires in a matrix formed from a polymeric material. The method may further comprise providing the cable core with a bimetallic cable core wire having a coaxial inner portion and outer portion, the inner and outer portions of the bimetallic cable core wire being formed of different metallic materials.

### BRIEF DESCRIPTION OF THE DRAWINGS

These and other features and advantages of the present invention will be better understood by reference to the following detailed description when considered in conjunction with the accompanying drawings wherein:

FIGS. 1A and 1B are a radial cross-sectional views of a prior art coaxial cable;

FIG. 2 is a radial cross-sectional view of a prior art hepta coaxial cable;

FIGS. 3A through 3D are radial cross-sectional views of a prior art triad configuration cable core;

FIG. 4 is a radial cross-sectional view of a prior art slickline coaxial cable with metallic tubing/cladding;

FIG. 5 is a radial cross-sectional view of a cable core;

FIG. 6 is a radial cross-sectional view of a coaxial cable including the cable core shown in FIG. 5;

FIGS. 7A and 7B are radial cross-sectional views of a slickline cable; and

FIGS. 8A through 8D are radial cross-sectional views of embodiments of slickline or wireline cables.

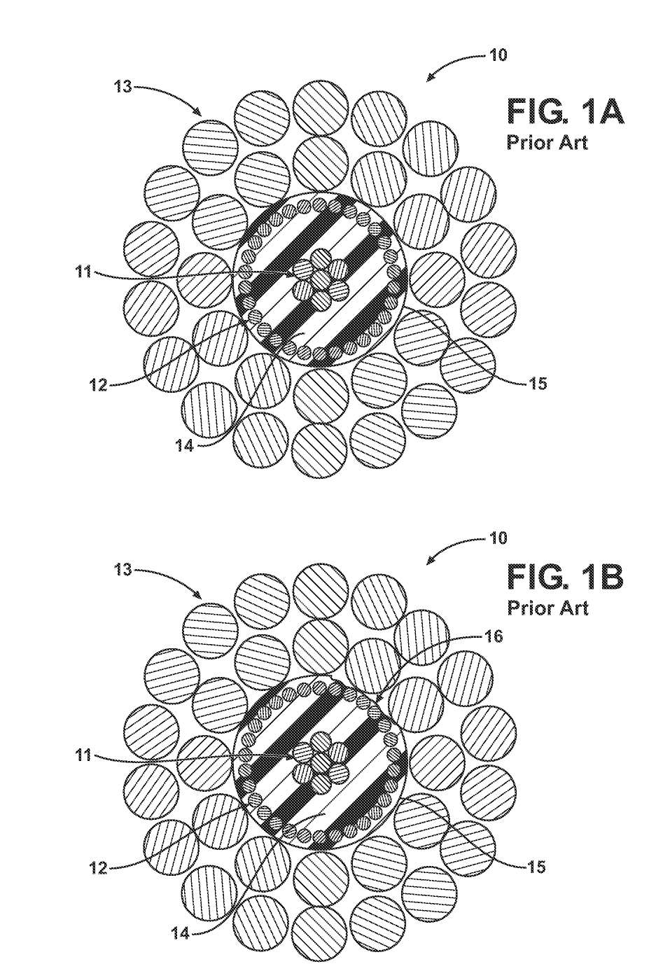

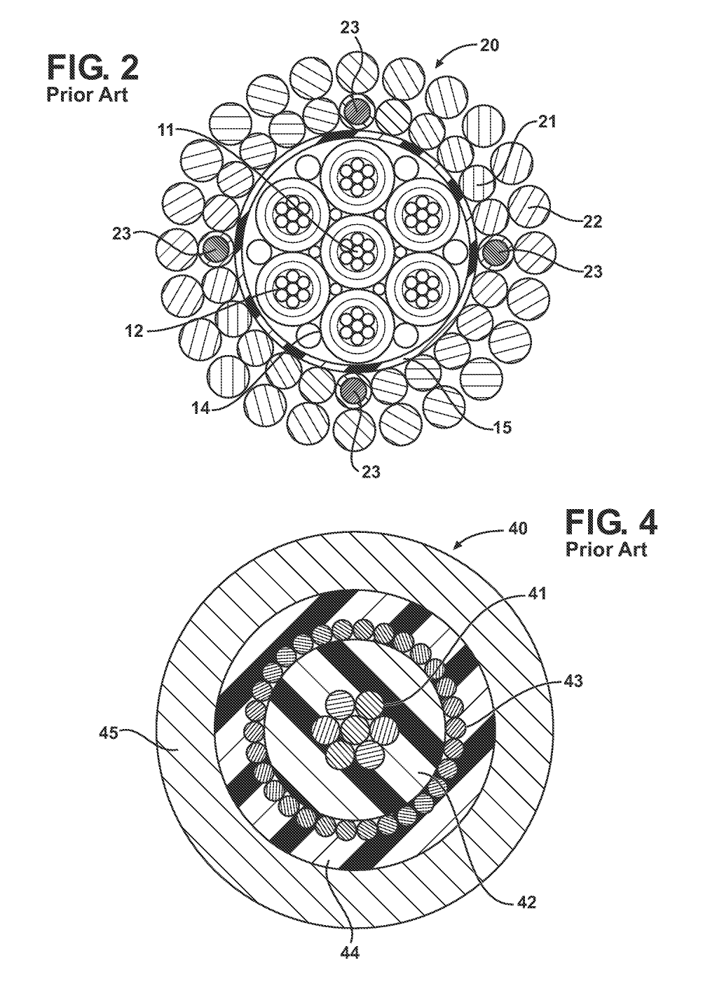

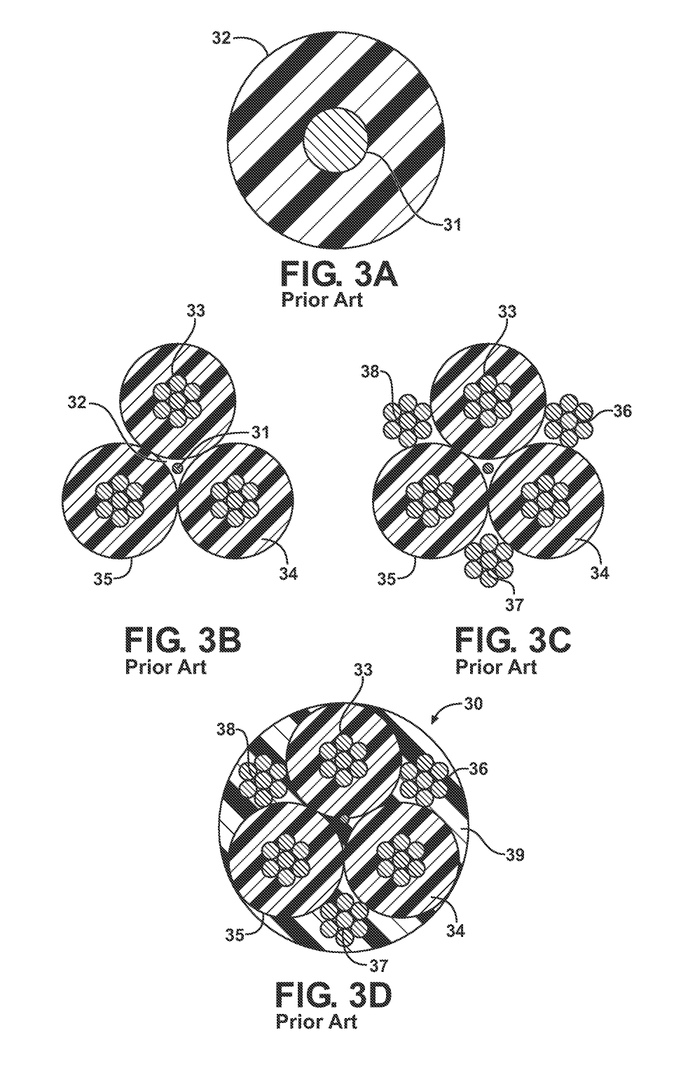

### DETAILED DESCRIPTION

Embodiments of cables also provide an alternative way of electrical power return utilizing corrosion resistant alloy armor wire. Embodiments of the cables employ mono cable core with contra helically wound alloy armor wire around the mono cable core, with the electrical return path through at least one armor wire(s) formed from bimetallic materials. The bimetallic armor wire preferably comprises highly conductive metal or alloy on an inside portion and a corrosion resistant metal alloy on an outside portion. The bimetallic armor wire could be utilized in slickline applications in the similar manner.

Embodiments of cables advantageously overcome the problems encountered with current alloy mono cable and coaxial cable designs while providing the ability to deliver power in excess of 0.5 kW over 30,000 feet of cable while also providing good telemetry capabilities.

Illustrative embodiments are described below. In the interest of clarity, not all features of an actual implementation are described in this specification. It will of course be appreciated that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

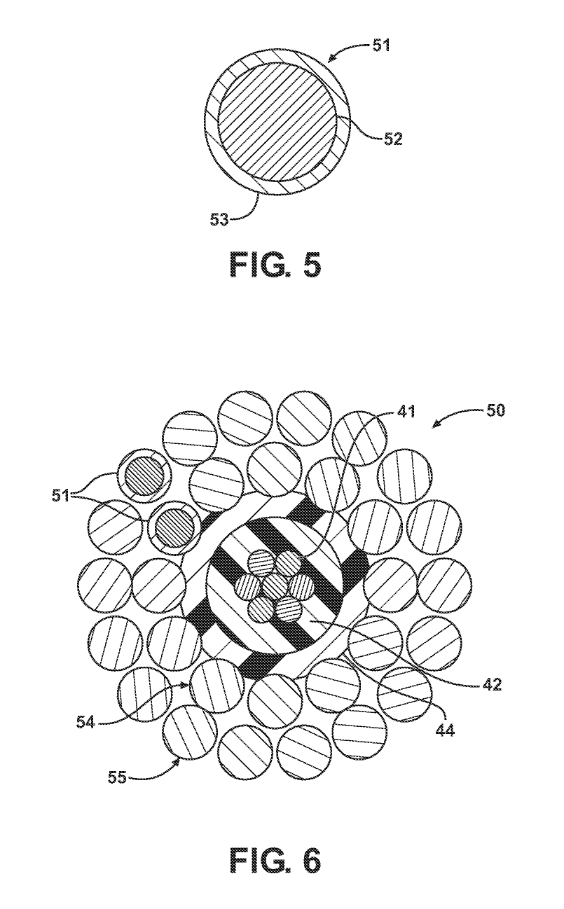

There is shown in FIGS. 5 and 6 an embodiment of a cable 50 with a small-diameter, high-power cable core with return path through bimetallic armor wire(s). The cable 50 includes a core comprising the conductor 41 extruded with insulating polymeric materials 42, 44, which is further served with two sets 54, 55 of armor wires contra helically wound around the core. One or more of the armor wires comprise bimetallic armor wires 51 to accommodate electrical power return. The bimetallic armor wire 51 comprises a coaxial inner portion 52 and an outer portion 53 formed of differing metals and/or alloys. The inner portion 52 comprises a highly conductive metal such as, but not limited to, copper, aluminum, beryllium copper or any other suitable highly electrically conductive material for electrical power delivery and telemetry evaluation. The outer portion 53 comprises a metal or alloy which acts as a strength and/or corrosion preventive metal alloy such as, but not limited to, MP35N, HC-265, Inconel, Monel, Rene or any other suitable corrosion resistant alloy or steel. The bimetallic armor wire 51 may be placed in either the inner armor layer 54 and/or the outer armor layer 55 as shown in FIG. 6. The number of bimetallic wires 51 in the cable 50 may vary depending upon power requirements, as will be appreciated by those skilled in the art.

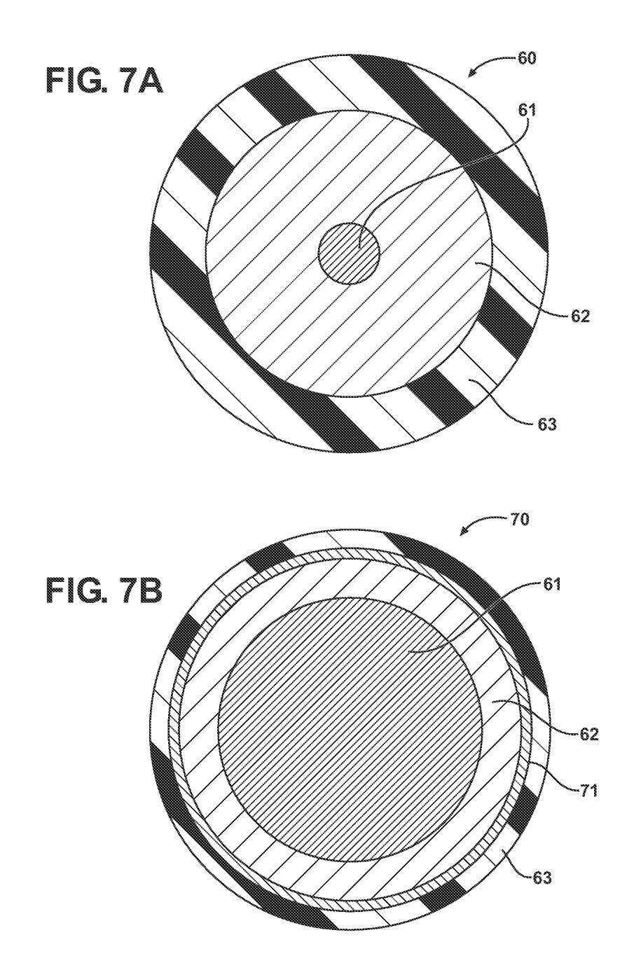

There is shown in FIG. 7A an embodiment of a small diameter highly conductive slickline cable 60. The slickline cable 60 comprises a single conductor 61 encased or covered with alloy or steel tubing/cladding 62 and further encased or covered by an extruded polymer jacket 63. The polymer jacket extrusion 63 is preferably directly applied over the alloy/steel shell 62, as shown in FIG. 7A. Alternatively, a thin layer of copper 71 is applied to the alloy/steel shell 62 prior to the polymer extrusion 63, as shown in FIG. 7B to form a slickline cable 70. The copper layer 71 in FIG. 7B acts as a bonding media between the alloy/steel shell 62 and the polymer jacket 63. Power return is preferably accomplished via the well casing (not shown).

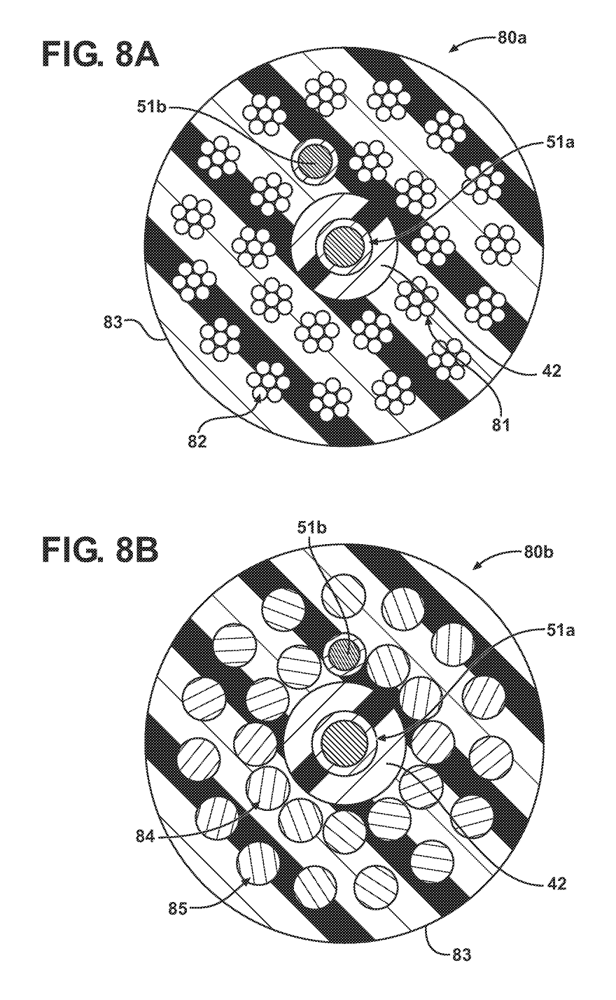

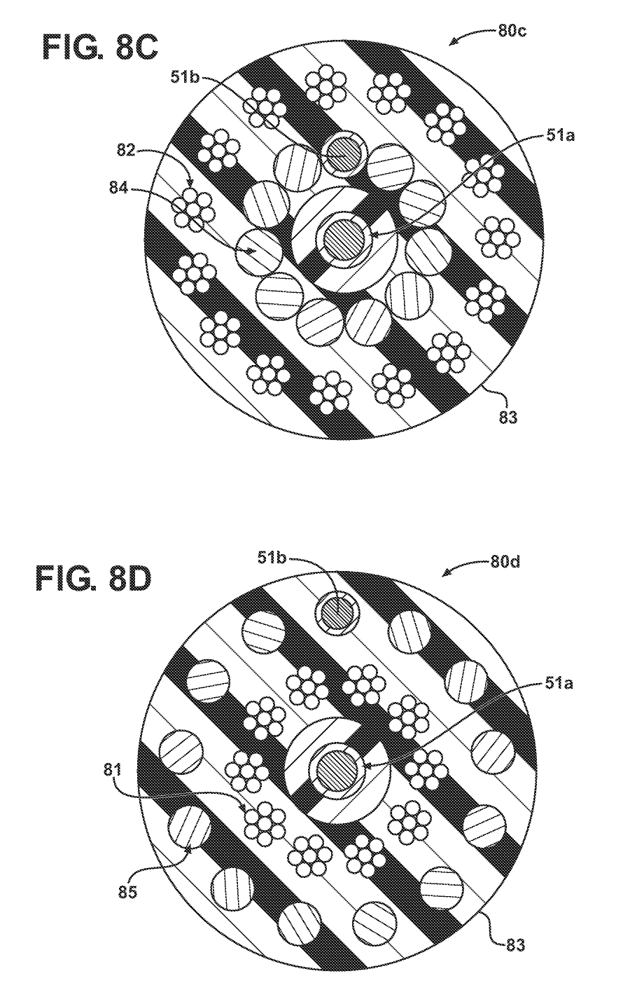

There is shown in FIGS. 8A through 8D, embodiments of small diameter highly conductive, low weight slickline or wireline cables with an alloy armor package utilizing a bimetallic armor wire, such as the armor wire shown in FIGS. 5 and 6 as the conductor or core and encased in an insulating polymer, and further encased or covered by a pair of armor wire layers in a matrix formed from a polymeric material. At least one of the armor wires is a bimetallic armor wire layer, providing the capability of electrical return via the armor wire.

FIG. 8A shows a cable 80a having the armor wire 51 utilized as a core conductor 51a encased in the insulating polymer 42. The polymer 42 is surrounded by an inner armor wire layer 81 which is surrounded by an outer armor wire layer 82. The layers 81, 82 are formed of stranded conductors and are encased in a matrix of polymeric material 83. At least one of the wires 51b in the layer 81 is the armor wire 51. FIG. 8B shows a cable 80b similar to the cable 80a except that an inner armor wire layer 84 and an outer armor wire layer 85 are formed of solid conductors. FIG. 8C shows a cable 80c similar to the cables 80a and 80b with the inner armor wire layer 84 and the outer armor wire layer 82. FIG. 8D shows a cable 80d similar to the cables 80a, 80b and 80c with the inner armor wire layer 81 and the outer armor wire layer 85.

Embodiments of cables eliminate the issue associated with serve layer manufacturing, prolong the life of the cable, and minimize the amount of real estate required for the comparable power delivery and mechanical functionality. Also the bimetallic center conductor could be replaced with a stranded nickel plated copper conductor which effectively results in an alloy slickline mono-cable configuration with return via the bimetallic armor wire. Furthermore, the electrical return path could be achieved on the inner or outer armor wire layers or both.

The bimetallic armor wire may be advantageously used as an electrical return path in any cable such as cables with mono, triad, quad or hepta configurations with alloy armor wires as strength members. The use of bimetallic armor wires advantageously allow alloy mono-cables to be constructed in excess of 30,000 feet in length.

The polymeric materials useful in the cable embodiments may include, by nonlimiting example, polyolefins (such as EPC or polypropylene), other polyolefins, polyaryletherether ketone (PEEK), polyaryl ether ketone (PEK), polyphenylene sulfide (PPS), modified polyphenylene sulfide, polymers of ethylene-tetrafluoroethylene (ETFE), polymers of poly(1,4-phenylene), polytetrafluoroethylene (PTFE), perfluoroalkoxy (PFA) polymers, fluorinated ethylene propylene (FEP) polymers, polytetrafluoroethylene-perfluoromethylvinylether (MFA) polymers, Parmax®, and any mixtures thereof.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values. Accordingly, the protection sought herein is as set forth in the claims below.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

We claim:

1. A cable, comprising:
an electrically conductive cable core for transmitting electrical power; and
at least one layer of a plurality of armor wires surrounding the cable core, wherein at least one of the armor wires is a bimetallic armor wire having a coaxial inner portion and a surrounding outer portion, the inner and outer portions of the at least one bimetallic armor wire being formed of different metallic materials, the at least one bimetallic armor wire adapted to provide a return path for the electrical power transmitted through the cable core.

2. The cable of claim 1 wherein the cable core includes a conductor extruded with at least one surrounding insulating polymeric material.

3. The cable of claim 1 wherein the cable core includes a bimetallic cable core wire having a coaxial inner portion and outer portion, the inner and outer portions of the bimetallic cable core wire being formed of different metallic materials.

4. The cable of claim 1 including a matrix formed from a polymeric material and encasing the cable core and the at least one layer of armor wires.

5. The cable of claim 1 wherein the inner portion of the bimetallic armor wire includes at least one of copper material, aluminum material, and beryllium copper material.

6. The cable of claim 1 wherein the outer portion of the bimetallic armor wire is formed of a metal alloy material which includes at least one of MP35N material, HC-265 material, Inconel material, Monel material, and Rene material.

7. The cable of claim 1 wherein the plurality of armor wires includes corrosion resistant alloy armor wires.

8. The cable of claim 1 wherein the at least one layer of armor wires is an inner layer and including an outer layer of a plurality of armor wires surrounding the inner layer, and wherein the at least one bimetallic armor wire is disposed in the inner layer.

9. The cable of claim 1 wherein the at least one layer of armor wires is an outer layer and including an inner layer of a plurality of armor wires surrounded by the outer layer, and wherein the at least one bimetallic armor wire is disposed in the outer layer.

10. The cable of claim 1 wherein the plurality of armor wires comprises an inner layer and an outer layer and wherein the at least one bimetallic armor wire is disposed in the inner layer and including at least another bimetallic armor wire disposed in the outer layer.

11. A cable, comprising:
an electrically conductive cable core formed from a first metallic material;
a metallic shell encasing the cable core and being formed from a second metallic material different than the first metallic material; and
a polymer jacket encasing the cable core and the shell.

12. The cable of claim 11 including a bonding material disposed between and attaching an outer surface of the shell and an inner surface of the polymer jacket.

13. The cable of claim 12 wherein the bonding material is a thin layer of copper material.

14. The cable of claim 11 wherein the first metallic material includes at least one of copper material, aluminum material, and beryllium copper material.

15. The cable of claim 11 wherein the second metallic material includes at least one of MP35N material, HC-265 material, Inconel material, Monel material, and Rene material.

16. The cable of claim 11 including at least one layer of a plurality of armor wires surrounding the polymer jacket.

17. A method of forming a cable, the method comprising:
providing an electrically conductive cable core for transmitting electrical power;
providing at least one bimetallic armor wire having a coaxial inner portion and a surrounding outer portion, the inner and outer portions being formed of different metallic materials; and
surrounding the cable core with at least one layer of a plurality of armor wires including the at least one bimetallic armor wire, wherein the at least one bimetallic armor wire provides a return path for the electrical power transmitted through the cable core.

18. The method of claim 17 including extruding at least one insulating polymeric material surrounding a conductor to form the cable core.

19. The method of claim 17 including encasing the at least one layer of armor wires in a matrix formed from a polymeric material.

20. The method of claim 17 including providing the cable core with a bimetallic cable core wire having a coaxial inner portion and outer portion, the inner and outer portions of the bimetallic cable core wire being formed of different metallic materials.
